(19) United States
(12) Patent Application Publication
(10) Pub. No.: US 2004/0176003 A1
(43) Pub. Date: Sep. 9, 2004

(54) Insulation product from rotary and textile inorganic fibers and thermoplastic fibers

(76) Inventors: Alain Yang, Bryn Mawr, PA (US); Gary Tripp, Sherman, TX (US)

Correspondence Address: DUANE MORRIS, LLP, IP DEPARTMENT, ONE LIBERTY PLACE, PHILADELPHIA, PA, 19103-7396, US

(21) Appl. No.: 10/807,058

(22) Filed: Mar. 23, 2004

Related U.S. Application Data
(63) Continuation-in-part of application No. 09/946,474, filed on Sep. 6, 2001.
(63) Continuation-in-part of application No. 09/946,476, filed on Sep. 6, 2001.
(63) Continuation-in-part of application No. 10/689,858, filed on Oct. 21, 2003.

(51) Int. Cl. B32B 5/02; B32B 27/04

(52) U.S. Cl. 442/120; 442/60

(57) ABSTRACT

A thermal and acoustical insulation product is fabricated from rotary glass fibers, thermoplastic fibers and a small quantity of textile fibers, all preferably scrap fibers, and at least one binder. The thermal and acoustical insulation product is optimal for applications, such as, duct liners, high density industrial insulation boards, and OEM insulation applications. The small amount of textile fibers enhance the mechanical strength of the insulation product.

### CROSS REFERENCE TO RELATED APPLICATIONS

The present application is a continuation of the following copending U.S. patent applications: U.S. patent application Ser. No. 09/946,474, filed on Sep. 6, 2001; U.S. patent application Ser. No. 09/946,476, filed on Sep. 6, 2001; U.S. patent application Ser. No. 10/689,858, filed on Oct. 22, 2003; U.S. patent application Ser. No. 10/766,052, filed on Jan. 28, 2004; U.S. patent application Ser. No. 10/781,994, filed on Feb. 19, 2004 for FORMALDEHYDE-FREE DUCT LINER; and U.S. patent application Ser. No. 10/782,275, filed on Feb. 19, 2004 for INORGANIC FIBER INSULATION MADE FROM GLASS FIBERS AND POLYMER BONDING FIBERS, which are commonly assigned and hereby incorporated by reference.

This application is also related to U.S. Pat. No. 6,673,280, issued on Jan. 6, 2004.

### FIELD OF THE INVENTION

The present invention relates to fiber glass insulation product and more particularly to an insulation product made from scrap rotary glass fibers and scrap nylon fibers reinforced with a small amount of scrap textile glass fibers.

### BACKGROUND OF THE INVENTION

Conventional fiber mats or webs used for thermal and acoustic insulation are made either primarily from textile fibers, or from rotary or flame attenuated fibers. ToughGard™ ductliners manufactured by CertainTeed Corporation of Valley Forge, Pa. is an example of insulation products made primarily from textile fibers. Textile fibers used in thermal and acoustic insulation are typically chopped into segments 2 to 15 cm long and have diameters of greater than 5 microns up to 16 microns. Rotary fibers and flame attenuated fibers are relatively short, with lengths on the order of 1 to 5 cm, and relatively fine, with diameters of 2 to 5 microns. Mats made from textile fibers tend to be stronger and less dusty than those made from rotary fibers or flame attenuated fibers, but are somewhat inferior in insulating properties. Mats made from rotary or flame attenuated fibers tend to have better thermal and acoustic insulation properties than those made from textile fibers, but are inferior in strength.

Thus, a need exists for new, low cost fiber products with a satisfactory combination of insulation, strength and handling characteristics.

### SUMMARY OF THE INVENTION

According to an aspect of the present invention, thermal and acoustical fiber composite insulation product made from rotary and textile glass fibers, thermoplastic fibers, and at least one binder is disclosed.

In a preferred embodiment of the present invention, the rotary glass fibers and the textile fibers may be scrap, virgin or a mixture of virgin and scrap fibers. Scrap rotary fibers may be, for example, scrap building insulation and/or metal-building insulation. Scrap thermoplastic fibers may be, for example, scrap nylon carpet fibers. A small amount of textile fibers is added to the fiber blend to provide reinforcement because textile fibers have higher tensile strength than the rotary fibers. The blend of the three fibers are bound together with at least one binder into an insulation mat or batt. The binder may be a thermosetting resin binder or a thermoplastic binder in liquid or powdered form.

In another embodiment of the present invention, a method of making a fiber glass insulation product is disclosed. Rotary glass fibers, thermoplastic fibers, and the textile fibers provided in bulk form, such as bales, along with the powdered or liquid binder are opened and blended. The fibers are then evenly spread on to a surface into a fibrous mat which is then cured or heated to form the final insulation mat. Generally, a facing layer, such as a non-woven, kraft or polyethylene film, is applied to at least one side of the mat before curing or heating the fibrous mat.

The preferred use of the scrap nylon fibers along with scrap glass fibers reduces manufacturing cost. Additional cost savings may also be realized by eliminating the manufacturer's disposal cost of scrap fibers. In addition, recycling of the scrap fibers provides an environmentally friendly alternative to discarding the scrap fibers in landfills. The blend of scrap rotary fibers, scrap thermoplastic fibers and scrap textile fibers used in the present invention also produces an insulation product having equivalent insulation property as the conventional textile fiber-based insulation products. Thus, the present invention provides a fiber glass insulation product that is less expensive than the conventional textile fiber-based insulation product but having an equivalent insulation property without much sacrifice on its strength.

In a further embodiment, a thermal and acoustical insulation product is made from a blended mixture of rotary and textile glass fibers, thermoplastic fibers and resinous binder. The rotary and textile glass fibers are bonded together by the combined adhesion caused by heating the blended mixture whereby the thermoplastic fibers and the resinous binder are disposed at least partially in molten state and thereafter cooling said heated blended mixture to ambient temperature to form the insulation product.

### BRIEF DESCRIPTION OF THE DRAWINGS

FIG. 1 is a schematic illustration of a cross-sectional view of an exemplary glass fiber insulation according to an embodiment of the present invention.

FIG. 2 is a schematic diagram illustrating a process for fabricating an insulation product from rotary and nylon scrap fibers according to an embodiment of the present invention.

FIG. 3 is a flow chart diagram of a process for fabricating the insulation product according to an embodiment of the present invention.

FIG. 4 is an enlarged view of a portion of the glass fiber insulation.

The features shown in the above referenced drawings are not intended to be drawn to scale nor are they intended to be shown in precise positional relationship. Like reference numbers indicate like elements.

### DETAILED DESCRIPTION OF THE INVENTION

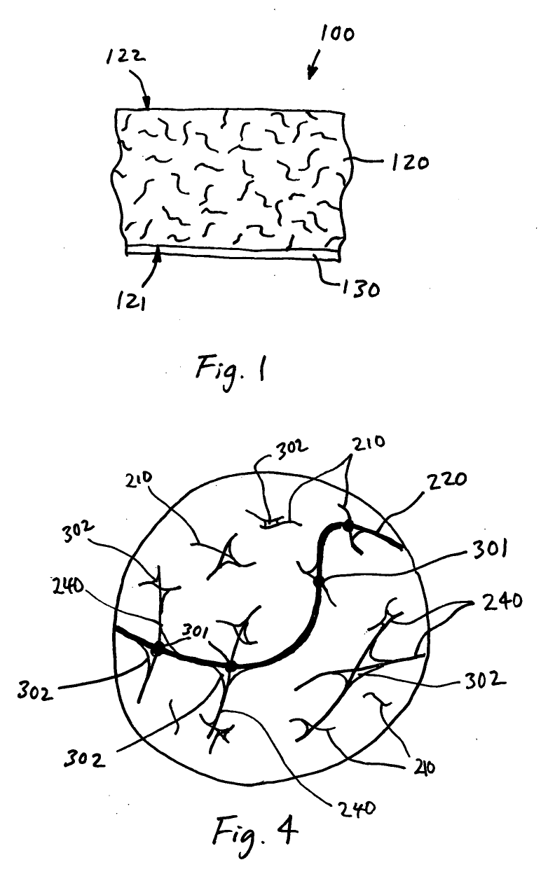

FIG. 1 is a cross-sectional view of a thermal and acoustical insulation product 100, according to a preferred embodiment of the present invention. The insulation product 100 comprises a fibrous insulation mat 120 having a first side 121, a second side 122 and a non-woven facing layer 130 bonded to the first side 121. The fibrous insulation mat 120 has a density of about 16 to 56 kg/m³ (1.0 to 3.5 pounds per cubic feet (pcf)) and preferably about 24 to 48 kg/m³ (1.5 to 3.0 pcf). The gram weight of the fibrous insulation mat 120 is in the range of about 530 to 3750 gm/m² and preferably about 700 to 3300 gm/m². The thickness of the insulation product 100 may be fabricated to be in the range of about 10 to 200 mm (about 0.5 to 8.0 inches) and preferably about 10 to 50 mm (about 0.5 to 2.0 inches).

FIG. 4 is a schematic illustration of a more detailed view of the bonded fiber matrix in the thermal and acoustical insulation product 100 of FIG. 1. The illustration depicts the preferred nature of the resinous bonds in the insulation product of the present invention. The rotary glass fibers 210 and textile glass fibers 240 are bonded together by the combined adhesion produced by heating the blended mixture of the fibers that includes thermoplastic fibers 220 and the resinous binder. In the heated state, the thermoplastic fibers 220 partially melt and form fiber-to-fiber melt bonds 301 directly between the thermoplastic fibers 220 and any other fiber that is in contact with the thermoplastic fibers at the intersection point of the two fibers (i.e. rotary fiber-to-thermoplastic fiber; textile fiber-to-thermoplastic fiber; and thermoplastic fiber-to-thermoplastic fiber) after the blended fiber mixture is cooled to ambient temperature. The resinous binder forms adhesive bonds 302 between any set of fibers that may be in contact or near each other. The melt bonds 301 formed by the thermoplastic fibers supplement the adhesive bonds 302 formed by the resinous binder.

In a preferred embodiment of the present invention, the fibrous insulation mat 120 may be fabricated from inorganic fibers, such as glass fibers comprising rotary fibers and textile fibers, thermoplastic fibers and at least one binder. All of the fiber materials may be scrap fibers to minimize the raw material cost.

The rotary glass fibers may have an average diameter of about 3 to 5 microns and preferably between 4 and 5 microns. The rotary glass fibers have an average length of less than about 100 mm (about 4 inches) and preferably less than about 75 mm (about 3 inches). In a preferred embodiment of the present invention, the rotary glass fibers may be scrap fibers, such as, for example, scrap building insulation batts or blown insulation fibers.

Textile glass fibers, which may preferably be scrap textile fibers, enhance the strength of the final insulation product. The textile fibers may have an average diameter of about 6 to 20 microns and average fiber length of about 13 to 130 mm (about 0.5 to 5 inches). The total glass fiber content of the insulation product of the present invention may be about 30 to 50 wt. % of the fibrous insulation mat 120 and the textile fiber content is preferably less than about 20 wt. % of the total glass fiber content of the final insulation product.

The thermoplastic fibers, which may also preferably be scrap fibers, used in the insulation product of the present invention may comprise about 30 to 50 wt. % of the final insulation product. The thermoplastic fibers are about 20 to 50 micrometers in diameter. The thermoplastic fibers are about 6 to 130 mm (about 0.25 to 5 inches) and preferably about 13 to 102 mm (about 0.5 to 4 inches) in length. Thermoplastic fibers made from thermoplastic resins which melt or form a melt adhesive bond with glass fibers at the same time and temperature that the resinous binder cures or melts (whether the resinous binder is cures or melts depends on whether the resinous binder is a thermoplastic type or a thermosetting type), are preferred. Such resins include nylon, acrylics, olefins, such as polyethylene and polypropylene, polyacryl ether, polyallomer, polysulfone, polyethersulfone, polyphenylene oxide, and polyvinyl chloride, for example. The thermoplastic fibers may be, for example, scrap nylon carpet fibers.

The fiber components are mixed with at least one resinous binder to make the insulation product of the present invention. The binder may be thermo-setting resin binders commonly used in the industry. Alternatively, thermoplastic powder binders may be used. Liquid and powdered binders are known and available for this use. See U.S. Pat. Nos. 5,883,020 and 4,751,134, which are incorporated herein by reference.

In the exemplary embodiment of the insulation product 100 of FIG. 1, a facing layer 130, such as a kraft, polyethylene film ornon-woven, is bonded to the first side 121 of the insulation mat. Some examples of facing layer material are non-woven glass or resin fibrous mats, polyethylene film and glass fiber scrim. Depending on the final application of the insulation product, non-woven facing layer may even be applied to both sides of the insulation mat or encapsulate the insulation mat if necessary. But, generally, at least one side of the insulation mat has a facing layer, which may or may not contain a vapor barrier.

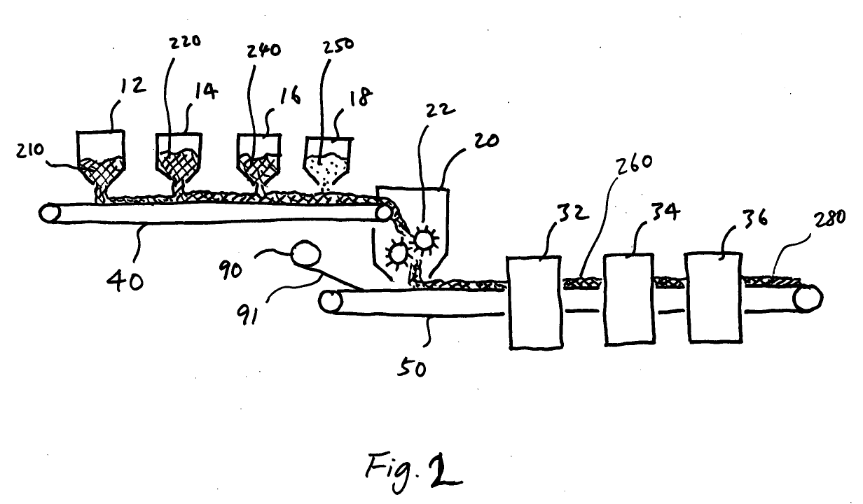

An exemplary process that may be employed in fabricating the insulation product according to an embodiment of the present invention will be described with reference to FIG. 2. In this example, scrap rotary glass fibers 210 are fed on to a blending conveyor 40 from a first storage bin 12. Scrap nylon fibers 220 are fed on to the blending conveyor 40 from a second storage bin 14. The scrap textile glass fibers 240 are fed on to the blending conveyor 40 from a third storage bin 16. Powdered resinous binder 250 (thermosetting resin or thermoplastic polymer) is then added to the mix of fibers on the blending conveyor 40 from a fourth storage bin 18. The powdered resinous binder is added in a quantity to be about 5 to 35 wt % and preferably about 10 to 20 wt. % of the final insulation product.

Before the mixture of the fibers and the powdered binder can be made into a mat form, the mixture is preferably processed through a tearing apparatus 20. The tearing apparatus 20 divides the fibers and evenly blends fibers and the powdered binder together. In the tearing apparatus 20, fibers are torn into fiber segments between opposed rotating bars 22 with teeth. In another embodiment of the present invention, a rotary scrap mat may be used instead of preprocessed rotary scrap glass fibers. The tearing apparatus 20 would be configured to handle the rotary scrap mat also.

As the divided-fibers and binder mixture exits the tearing apparatus 20, the mixture is evenly spread on to the surface of a forming conveyor 50 and formed into a fibrous mat 260 in a vacuum forming hood 32. Additional fiber blending devices may be employed between the tearing apparatus 20 and the vacuum forming hood 32 to further blend the mixture and adjust the openness of the fibers if necessary. In the vacuum forming hood 32, a vacuum is generally applied to the bottom of the forming conveyor 50 to pull the fiber/binder mixture against the forming conveyor 50 to form the fibrous mat 260. The fibrous mat generally has a gram weight of about 530 to 3750 gm/m² and preferably about 700 to 3300 gm/m².

Generally, a glass fiber or other non-woven facing layer 91 is provided on the surface of the forming conveyor 50 so that the facing layer 91 bonds to the bottom side of the fiber mat during the subsequent curing or heating step. In another embodiment of the present invention, a second facing layer may be provided from a supply roll 90 on to the top side of the fiber mat before the mat enters the curing or heating oven 34. In other words, the facing layer 91 is applied to at least one of the two sides of the mat

The fibrous mat 260 is then transported by the forming conveyor 50 to the curing or heating oven 34. In the oven 34, the fibrous mat 260 is subjected to an elevated temperature appropriate for curing or heating the binder to fix the fibrous mat at a desired thickness and form a final insulation mat 280. Whether the fibrous mat 260 is cured or just heated depends on the type of binder used, as thermoplastic binders do not cure. For a typical resin binder used in this application, e.g. phenolic resin binder, the curing temperature may be set about 200 to 270° C.

The final insulation mat 280 leaving the oven 34 may be cooled in a cooling station 36 and then sized and packaged for shipping. The thickness of the final insulation mat 280 may be fabricated to be in the range of about 10 to 200 mm (about 0.5 to 8.0 inches) and preferably about 10 to 50 mm (about 0.5 to 2.0 inches). However, the fiber glass composite insulation material of the present invention may be used for a variety of types of insulation products and the final thickness, density, and gram weight of a particular insulation product may be determined by the levels of acoustic and/or thermal insulation that are desired or necessary for a particular application.

The insulation mat of the present invention is optimally suited for insulation product applications such as building insulation batts, duct liners, industrial high density insulation products such as duct boards, and OEM insulation products.

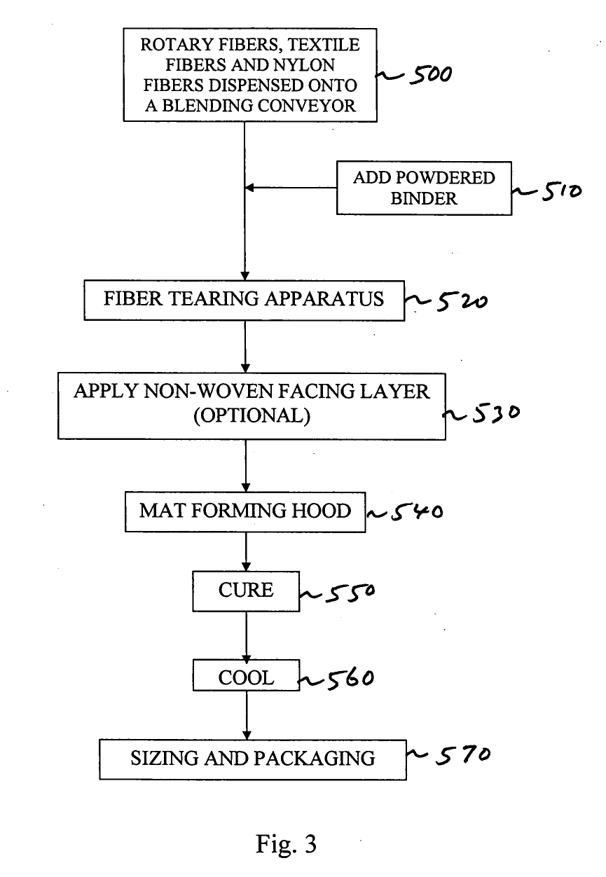

FIG. 3 illustrates a flow chart diagram of the exemplary process.

At step 500, rotary fibers, nylon fibers, and textile fibers are fed on to a blending conveyor.

At step 510, at least one binder (thermosetting resin binder or thermoplastic binder) is added to the fiber mixture on the blending conveyor.

At step 520, the fiber/binder mixture is divided into smaller segments, opened, and evenly spread on to a forming conveyor.

At step 530, optionally a non-woven facing layer may be applied to the forming conveyor surface first before the fiber/binder mixture is spread on to the forming conveyor in step 520.

At step 540, the opened and blended fiber/binder mixture is formed into a fibrous mat through a vacuum forming hood.

At step 550, the fibrous mat is cured or heated in a curing or heating oven to form a final insulation mat having a desired thickness.

At step 560, the final insulation mat may be cooled in a cooling station.

At step 570, the cured insulation mat may be sized and packed for shipping.

While the foregoing invention has been described with reference to the above embodiments, various modifications and changes can be made without departing from the spirit of the invention. Accordingly, all such modifications and changes are considered to be within the scope of the appended claims.

What is claimed is:

1. A thermal and acoustical insulation product comprising:
rotary glass fibers;
thermoplastic fibers;
textile fibers; and
at least one binder.

2. The thermal and acoustical insulation product of claim 1, wherein said rotary fibers comprise scrap fibers.

3. The thermal and acoustical insulation product of claim 1, wherein said thermoplastic fibers comprise scrap nylon fibers.

4. The thermal and acoustical insulation product of claim 1, wherein said textile fibers comprise scrap fibers.

5. The thermal and acoustical insulation product of claim 1, wherein said thermoplastic fibers are about 6 to 130 mm in length.

6. The thermal and acoustical insulation product of claim 1, wherein said thermoplastic fibers are about 13 to 102 mm in length.

7. The thermal and acoustical insulation product of claim 1, wherein said thermoplastic fibers have a diameter of about 20 to 50 micrometers.

8. The thermal and acoustical insulation product of claim 1, wherein said thermoplastic fibers make up about 30 to 50 wt. % of said insulation product.

9. The thermal and acoustical insulation product of claim 1, wherein said rotary fibers have an average diameter of about 3 to 5 micrometers.

10. The thermal and acoustical insulation product of claim 1, wherein said rotary fibers have an average diameter of about 4 to 5 micrometers.

11. The thermal and acoustical insulation product of claim 1, wherein said rotary fibers have an average fiber length of less than about 100 mm.

12. The thermal and acoustical insulation product of claim 1, wherein said rotary fibers have an average fiber length of less than about 75 mm.

13. The thermal and acoustical insulation product of claim 1, wherein said insulation product has a total glass fiber content of about 30 to 50 wt. %.

14. The thermal and acoustical insulation product of claim 13, wherein said textile fibers make up less than about 20 wt. % of the total glass fiber content of said insulation product.

15. The thermal and acoustical insulation product of claim 1, wherein said textile fibers have an average diameter of about 6 to 20 micrometers.

16. The thermal and acoustical insulation product of claim 1, wherein said textile fibers have an average fiber length of about 13 to 130 mm.

17. The thermal and acoustical insulation product of claim 1, wherein said insulation product has a gram weight in the range of about 530 to 3750 gm/m².

18. The thermal and acoustical insulation product of claim 1, wherein said insulation product has a gram weight in the range of about 700 to 3300 gm/m².

19. The thermal and acoustical insulation product of claim 1, wherein said insulation product has a density in the range of about 16 to 56 kg/m³.

20. The thermal and acoustical insulation product of claim 1, wherein said insulation product has a density in the range of about 24 to 48 kg/m³.

21. The thermal and acoustical insulation product of claim 1, wherein said insulation product has a thickness of about 10 to 200 mm.

22. The thermal and acoustical insulation product of claim 1, wherein said insulation product has a thickness of about 10 to 50 mm.

23. The thermal and acoustical insulation product of claim 1, wherein said binder is a thermosetting resin powdered binder at about 5 to 35 wt. % of said insulation product.

24. The thermal and acoustical insulation product of claim 1, wherein said binder is a thermosetting resin powdered binder at about 10 to 20 wt. % of said insulation product.

25. The thermal and acoustical insulation product of claim 1, wherein said binder is a thermoplastic powdered binder at about 5 to 35 wt. % of said insulation product.

26. The thermal and acoustical insulation product of claim 1, wherein said binder is a thermoplastic powdered binder at about 10 to 20 wt. % of said insulation product.

27. A thermal and acoustical insulation batt comprising:
a fibrous insulation mat having a first side and a second side, said mat comprising:
rotary glass fibers;
thermoplastic fibers;
textile glass fibers; and
at least one binder, wherein a non-woven facing layer is bonded to at least one of said two sides of the fibrous insulation mat.

28. The thermal and acoustical insulation batt of claim 27, wherein said rotary glass fibers comprise scrap fibers.

29. The thermal and acoustical insulation batt of claim 27, wherein said thermoplastic fibers comprise scrap nylon fibers.

30. The thermal and acoustical insulation batt of claim 27, wherein said textile glass fibers comprise scrap fibers.

31. The thermal and acoustical insulation batt of claim 27, wherein said thermoplastic fibers are about 6 to 130 mm in length.

32. The thermal and acoustical insulation batt of claim 27, wherein said thermoplastic fibers are about 13 to 102 mm in length.

33. The thermal and acoustical insulation batt of claim 27, wherein said thermoplastic fibers have an average diameter of about 20 to 50 micrometers.

34. The thermal and acoustical insulation batt of claim 27, wherein said thermoplastic fibers make up about 30 to 50 wt. % of said insulation batt.

35. The thermal and acoustical insulation batt of claim 27, wherein said rotary fibers have an average diameter of about 3 to 5 micrometers.

36. The thermal and acoustical insulation batt of claim 27, wherein said rotary fibers have an average diameter of about 4 to 5 micrometers.

37. The thermal and acoustical insulation batt of claim 27, wherein said rotary fibers have an average fiber length of less than about 100 mm.

38. The thermal and acoustical insulation batt of claim 27, wherein said rotary fibers have an average fiber length of less than about 75 mm.

39. The thermal and acoustical insulation batt of claim 27, wherein said insulation batt has a total glass fiber content of about 30 to 50 wt. %.

40. The thermal and acoustical insulation batt of claim 27, wherein said textile fibers make up less than about 20 wt. % of the total glass fiber content of said insulation batt.

41. The thermal and acoustical insulation batt of claim 27, wherein said textile fibers have an average diameter of about 6 to 20 micrometers.

42. The thermal and acoustical insulation batt of claim 27, wherein said textile fibers have an average fiber length of about 13 to 130 mm.

43. A method of making a thermal and acoustical insulation mat, comprising the steps of:
(a) mixing rotary glass fibers, thermoplastic fibers, textile glass fibers and at least one binder into a fiber/binder mixture;
(b) dividing and blending the fiber/binder mixture into a fiber/binder blend;
(c) forming the fiber/binder blend into a fibrous mat having a first side and a second side; and
(d) curing or heating the fibrous mat into the thermal and acoustical insulation mat.

44. The method of claim 43, further comprising the step of:
applying a non-woven facing layer to at least one of the first and the second sides of the fibrous mat before the curing or heating step.

45. The method of claim 43, wherein said binder and said thermoplastic fibers are heated simultaneously to provide a melt bond during said curing or heating step.

46. The method of claim 43, wherein said binder is a heat curable thermosetting resin, said thermoplastic fibers being melt bonded to said textile glass fibers and said rotary glass fibers and said heat curable thermosetting resin being heat cured to form an adhesive bond with said textile glass fibers and said rotary glass fibers during said curing or heating step (d).

47. The method of claim 44, wherein said curing or heating step (d) comprises a temperature at which said thermoplastic fibers and said binder are at least partially molten at the same time.

48. A thermal and acoustical insulation product comprising:
a blended mixture of rotary and textile glass fibers, thermoplastic fibers and resinous binder, said rotary and textile glass fibers being bonded together by the combined adhesion caused by heating said blended mixture whereby said thermoplastic fibers and said resinous binder are disposed at least partially in molten state and thereafter cooling said heated blended mixture to ambient temperature to form said insulation product.

49. The insulation product of claim 48, wherein said thermoplastic fibers comprise nylon.

50. The insulation product of claim 48, wherein said resinous binder is a powdered or liquid, thermosetting or thermoplastic biner.
